(19) United States
(12) Patent Application Publication
(10) Pub. No.: US 2020/0061729 A1
(43) Pub. Date: Feb. 27, 2020

(54) EDM MILLING ELECTRODE

(71) Applicant: GLOBAL INNOVATIVE PRODUCTS, LLC, Mason, OH (US)

(72) Inventors: DANDRIDGE TOMALIN, Mason, OH (US); BRAD HANSARD, Morrow, OH (US); KATSUNORI CHIBA, Yokohama City, Kanagawa (JP)

(21) Appl. No.: 16/346,643

(22) PCT Filed: Nov. 2, 2017
(86) PCT No.: PCT/US17/59656

§ 371 Date: May 1, 2019

Related U.S. Application Data
(60) Provisional application No. 62/417,634, filed on Nov. 4, 2016.

(51) Int. Cl. B23H 7/08; B23H 1/06; B23H 11/00; B23K 35/02; B23K 35/28; B23K 35/30; B23K 35/40; C22C 9/04; C22F 1/08; C23C 8/10; C23C 28/00; C25D 5/50

(52) U.S. Cl. CPC B23H 7/08; B23H 1/06; B23H 11/00; B23K 35/0216; B23K 35/0272; B23K 35/282; C25D 5/50; B23K 35/40; C22C 9/04; C22F 1/08; C23C 8/10; C23C 28/3225; C23C 28/345; B23K 35/302

(57) ABSTRACT

An apparatus for an electrical discharge machine for milling a shaped cavity in a workpiece includes a hollow electrode having a metallic inner shell with at least one passage for receiving dielectric fluid. A layer including at least one brass alloy is provided over the inner sheel and exhibits a zinc content greater than a zinc content of the inner shell.

### RELATED APPLICATIONS

This application clams priority from U.S. Provisional Application Ser. No. 62/417,634, filed 4 Nov. 2016, which is incorporated herein by reference in its entirety.

### TECHNICAL FIELD

The present invention relates generally to EDM milling and, more specifically, relates to an EDM milling electrode coated with a layer of a high zinc content brass alloy phase or duplex phases.

### BACKGROUND

Electrical Discharge Machining (EDM) technology is a non-traditional machining method used to create intricate contours or cavities in pre-hardened steel or any other electrically conductive metal or metal alloy system such as those of titanium, temperature-resistant super alloys, and tungsten carbide. Since its origin in the mid 1940's in Russia, it has evolved into three main branches, namely, sinker EDM, wire EDM, and fast hole drilling EDM. All three branches are based on the same basic principal of EDM in which an electrode is brought within close proximity of a workpiece and the gap between the two is filled with a dielectric fluid. A pulsed electric potential is applied to create sequential discharge events, which erode the workpiece to shape the desired contour.

The details of the process in each branch of EDM vary widely and have not resulted in much technology transfer between branches with regard to electrode construction. For example, copper electrodes are commonly used in sinker and fast hole drilling EDM but sparingly applied to wire EDM because the gap geometry and energy transfer at each discharge event in wire EDM are significantly different from those in sinker or drilling applications. As a result, sophisticated coated electrode constructions have been adopted in wire EDM but rarely proposed for sinker or fast hole drilling applications.

The reason is that in sinker EDM, thin coatings have little impact on the electrode performance as they would be rapidly eroded at high currents such as those employed in sinker and milling applications. This rapid erosion is not an issue in wire EDM since fresh wire is continually being presented to the gap. Furthermore, the surface erosion in wire EDM has less impact on performance, particularly when the wire transfer speed can be adjusted to compensate for the erosion, and when one considers the significantly slower cutting speeds that are experienced in wire EDM applications.

In the case of fast hole drilling EDM, it is known (see Habel—U.S. Pat. No. 5,614,108), that substantially all, if not all, of the EDM machining occurs at the end of the tubular electrode where the dielectric fluid exits the gap between the electrode and the workpiece and not along the length of the tube where coatings would be applied. If thin coatings analogous to those employed in wire EDM constructions were to be applied to typical fast hole drilling electrode tubes, the coating cross-sectional area exposed to the bottom of the cavity being eroded would project less than five area percent of the total tube electrode area exposed, i.e. the coating would at best have minimal effect on the tube electrode's erosion performance.

Habel suggested that the efficiency of fast hole EDM can be compromised by power losses due to current leakage through the dielectric fluid between the electrode and the side wall of the hole being machined in the workpiece. As a result, Habel proposed coating the exterior surfaces of fast hole electrode tubes with an electrically insulating polymer material such as polyamide. In the intervening 20 plus years since that proposal no polymer coated, or for that matter any coated tube electrode constructions, have been proposed or introduced for the fast hole drilling EDM application. Therefore, the impact of Habel's suggestion is in doubt and has yet to be verified.

In the prior art of the wire and fast hole drilling branches of EDM, the function and role coatings could play vary dramatically because of the differences in operating conditions. In wire EDM the function of diffusion annealed coatings is to enhance the flushing of process debris (see Tomalin—U.S. Pat. No. 5,945,010) since the stability of the gap is easily compromised at the low currents employed. In addition, a thin (about 1 μm) zinc oxide outer layer on the diffusion annealed coatings (which typically are performed in an air atmosphere) are viewed as acting as a semi-conductor barrier, preventing short circuits that terminate the sequential discharge events (see Brifford—U.S. Pat. No. 4,341,939). By way of contrast, in fast hole drilling little attention has been paid to the role of coatings and their influence on flushing, or for that matter to the role of flushing as it relates to any of the physical or chemical properties of the tube electrodes since it has evolved into a significantly higher current application where short circuits are considered to be a fact of life which must be tolerated. The issue of flushing has not been thought of as being subtle, or for that matter to be important, and has thus far been addressed by managing the hydraulic aspects of flushing with multi-channel tubes and higher water pressures that attempt to overpower the issue by brute force.

The added aspect of complex hole shaping which has been introduced to many fast hole drilling EDM applications (see—Forrester (U.S. Pat. No. 7,041,933), Wei (U.S. Pat. No. 7,394,040), Mironets (U.S. Pat. No. 8,710,392), Lian (U.S. Pat. No. 8,858,176), and Kliev (18^{th} CIRP Conference on Electro Chemical Machining—Procedia CIRP 42 (2016) pg. 322-327) also creates an incentive to improve the performance of the tube electrodes to make the EDM application more competitive with the competing non-traditional machining alternative process of laser drilling. The current invention considers the role of coated electrode tubes in the fast hole drilling EDM application and provides significant improvements in the machining efficiencies of those applications as a result.

### SUMMARY

In accordance with an embodiment of the present invention, an apparatus for an electrical discharge machine for milling a shaped cavity in a workpiece includes a hollow electrode having a metallic inner shell with at least one passage for receiving dielectric fluid. A layer having at least one brass alloy is provided over the inner shell and exhibits a zinc content greater than a zinc content of the inner shell.

In another example, a method of forming an electrode for an electrical discharge machine for drilling a hole in a workpiece includes providing a metallic inner shell having at least one passage for receiving dielectric fluid. A layer of zinc is deposited over the inner shell to form a composite electrode. The composite electrode is heat treated in an oxygen environment to form a layer having at least one brass alloy over the inner shell. The composite electrode is drawn down to a finish diameter.

Other objects and advantages and a fuller understanding of the invention will be had from the following detailed description and the accompanying drawings.

### BRIEF DESCRIPTION OF THE DRAWINGS

FIG. 1 is a schematic illustration of an example apparatus for performing EDM milling.

FIG. 2 is an enlarged view of a portion of FIG. 1.

FIG. 3 is a front view of an EDM milling electrode for the apparatus of FIG. 1.

FIGS. 4A-4C are alternative configurations for the longitudinal cross-section of the electrode of FIG. 3.

FIG. 5A is a schematic illustration of a prior art EDM wire construction.

FIG. 5B is a schematic illustration of the EDM milling electrode of FIG. 3 having a coating in accordance with the present invention.

FIG. 6 is a metallographic image of a cross-section of a first sample tube electrode of the present invention.

FIGS. 7A-7C are metallographic images of cross-sections of the first sample tube electrode at different locations around its circumference.

FIG. 8 is a metallographic image of a cross-section of a second sample tube electrode of the presented invention.

FIG. 9 is a metallographic image of a cross-section of a third sample tube electrode of the present invention.

FIG. 10 is a metallographic image of a cross-section of a fourth sample tube electrode of the present invention.

FIG. 11 is a metallographic image of a cross-section of the fourth sample tube electrode at a different stage of manufacturing than FIG. 10.

### DETAILED DESCRIPTION

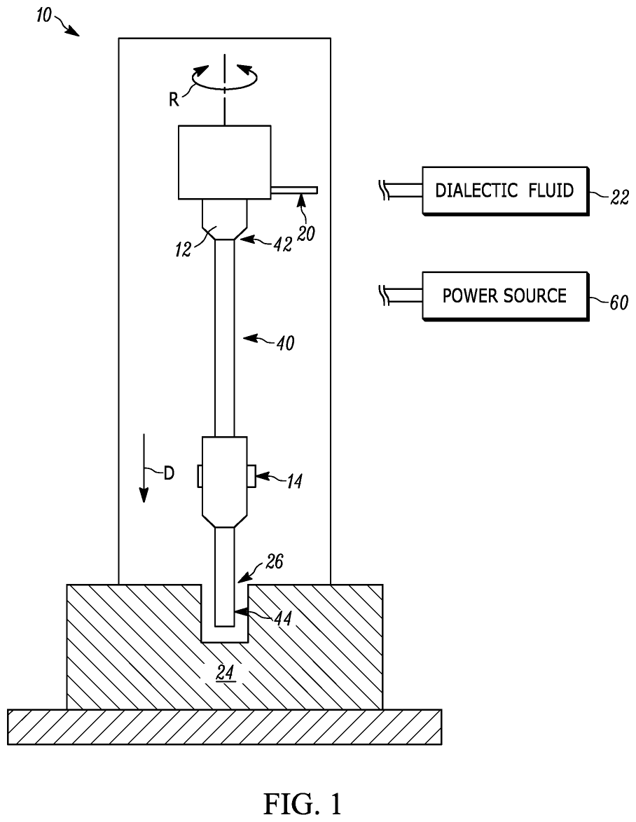

The present invention relates generally to EDM milling and, more specifically, relates to an EDM milling electrode coated with high zinc content brass alloys. FIG. 1 shows an apparatus 10 for performing EDM milling, e.g., fast-hole drilling, on a workpiece 24. The apparatus 10 includes a spindle 12 and an electrode guide 14 that cooperate to receive an EDM electrode 40. The electrode 40 is rotatable by the spindle 12 in the direction generally indicated by the arrow R. Alternatively, the spindle 12 could be held stationary (not shown). The electrode 40 is also movable in a longitudinal direction D (vertical as shown) by the apparatus 10 towards the workpiece 24 during operation of the apparatus 10 and as the electrode 40 wears, i.e., shortens.

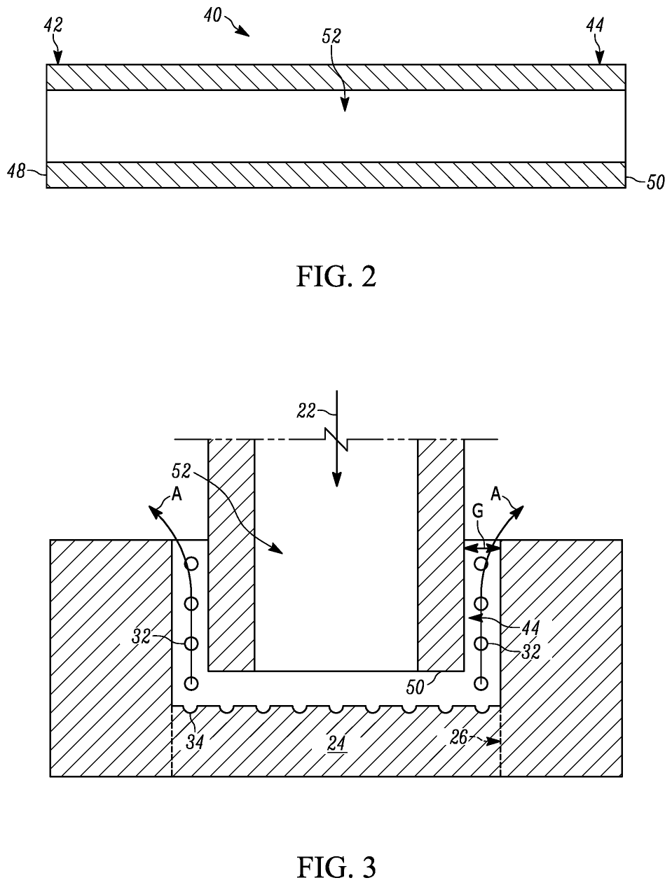

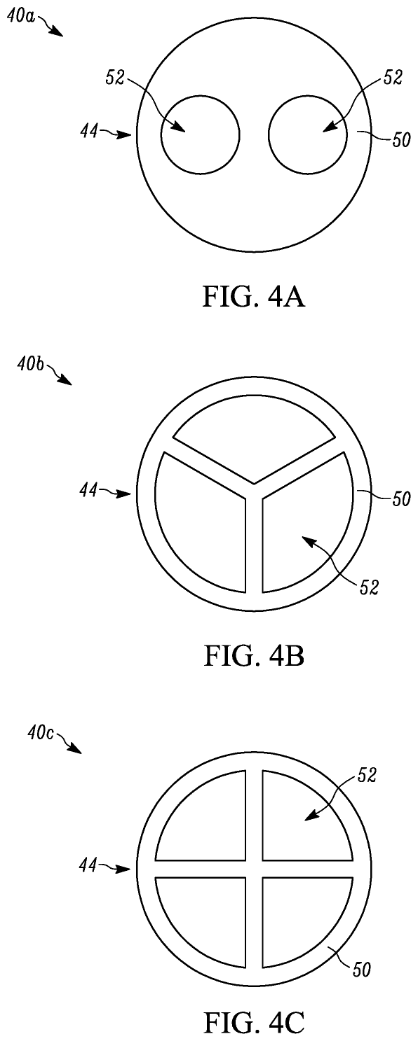

Referring to FIGS. 1-3, the electrode 40 is hollow and elongated, extending from a first end 42 to a second end 44. The first end 42 terminates at an axial end face 48. The second end 44 terminates at an axial end face 50. A passage 52 extends through the electrode 40 from the end face 48 to the end face 50. Alternatively, as shown in FIGS. 4A-4C, the electrode 40 can include two passages 52 (FIG. 4A), three passages (FIG. 4B) or four passages (FIG. 4C). In any case, each passage 52 can have a round or polygonal cross-section.

As shown in FIG. 1, the first end 42 of the electrode 40 extends into and is held by the spindle 12. The electrode 40 also extends through the guide 14 such that the second end 44 extends below the guide. A source of dielectric fluid 22, e.g., deionized water, is fluidly connected to an inlet 20 on the apparatus 10.

In operation, the workpiece 24 is positioned beneath the electrode 40 in a desired orientation. The electrode 40 is rotated in the direction R and high pressure, dielectric fluid 22 is supplied to the passages 52 via the inlet 20. A power source 60 electrically connected to the electrode 40 applies a pulsed electric potential thereto. When the end 44 of the electrode 40 is in close proximity with the workpiece 24, the intensity of the electric field generated in the electrode is sufficient to form an electrical discharge in a gap G between the end 44 and the workpiece. In other words, current flows between the end 44 of the electrode 40 and the workpiece 24. As a result, particles 32 are removed from the workpiece 24 and the electrode 40 to form recesses 34 therein. The dielectric fluid 22 helps flush the removed particles 32 from the workpiece 24 in the manner generally indicated by the arrow A. Continued removal of the particles 32 eventually forms a shaped cavity and/or hole 26 in the workpiece 24. This hole 26 can extend entirely through the workpiece 24 (indicated in phantom in FIG. 3). With that said, the present invention introduces a coating for the electrode 40 that significantly improves hole drilling performance over existing electrodes for fast-hole drilling EDM machines.

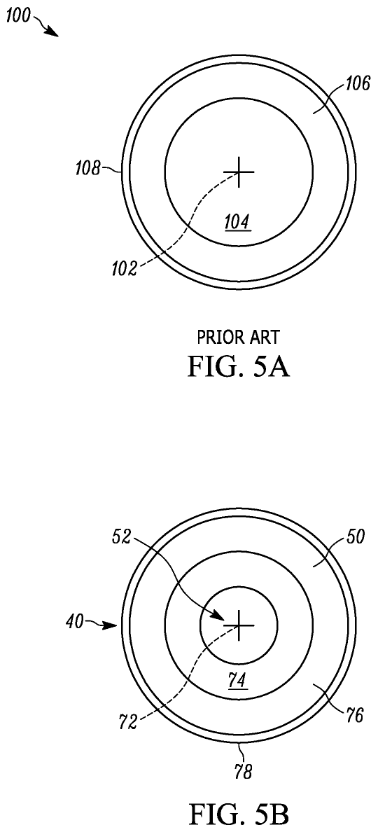

An example of an existing, high performance diffusion annealed, coated EDM wire 100 is shown in FIG. 5A. The wire 100 extends along a longitudinal centerline 102 and includes a core 104 formed at least in part from copper. At least one high zinc content brass alloy layer 106 is provided on the core 104. The thickness of the brass alloy layer 106 is about 4 μm-15 μm, depending on its phase type(s).

The brass alloy layer 106 is formed by diffusion annealing, which typically is performed in air. As a result, a zinc oxide layer 108 is formed on the surface of the brass alloy layer 106. Prior art EDM wire constructions limited the thickness of the zinc oxide layer 108 to about 1 μm since its effectiveness as a semi-conductor barrier decreases with thickness at the low currents typically employed.

The present invention improves this coating concept for adaptation to the high current milling application by increasing the thickness of a brass alloy 76 layer on the electrode 40 compared to the wire 100 to create a significant area percentage of the total exposed area of the end face 50 projected on the discharge location across the gap G in the workpiece 24. Optionally, a heavier zinc oxide layer can be provided on the electrode 40 to limit current leakage along the gap G between the side of the end 44 of the tubular electrode 40 and the wall of the hole 26 being milled. The oxide layer, however, can be omitted.

To this end, FIG. 5B illustrates an axial cross-section of the coated electrode 40 in accordance with the present invention. The electrode 40 extends along a longitudinal centerline 72 and includes a core inner shell 74. The core inner shell 74 is formed at least in part from, for example, copper, or a copper zinc alloy. At least one high zinc content brass alloy phase layer 76 is provided on the core inner shell 74. The brass alloy layer 76 could be a single phase layer, e.g., β-phase brass or γ-phase brass, or sequential single phase layers one on top of another, e.g., discontinuous γ-phase brass over β-phase brass. Alternatively, the brass alloy layer 76 can include a two phase mixture, e.g., β-phase precipitates in a γ-phase matrix, γ-phase precipitates in a β-phase matrix, or any combination of layers thereof. In any case, the thickness of the brass alloy layer 76 is typically 10-40 μm.

The brass alloy layer 76 is formed by diffusion annealing, which typically is performed in air or an oxygen enriched environment. More specifically, a zinc layer is provided on the core inner shell 74 by, for example, electroplating, to form a composite electrode. The composite electrode is then diffusion annealed to transform the zinc layer into the brass alloy layer or layers 76. The first heat treatment can be at a temperature of about 150° C.-160° C. A second heat treatment can be about 275° C.-500° C. Either heat treatment can last from about 7-16 hours. The composite electrode 40 is subsequently drawn to a finish diameter and cut to length, typically 300-400 mm. The zinc oxide layer 78 can be removed from the electrode 40 prior to or following drawing.

The specific construction of the brass alloy layer 76 depends on the annealing temperature, time, and number of different heat treatments performed on the tube electrode 40. Since the diffusion annealing is performed in an oxygen containing atmosphere, the outer portion of the zinc layer exposed to air is oxidized to form an outer zinc oxide layer 78 extending at least partially over the surface of the brass alloy layer 76 after drawing and finish processing to straighten and size the electrode 40.

The diffusion annealing process described herein allows one to advantageously thicken the oxide layer 78 to convert it from a semi-conductor to more of an insulating layer by adjusting the heat treating process parameters of time, temperature, and/or atmosphere. As a result, the thickness of the zinc oxide layer 78 can be as thick as 15 μm and as thin as 0 μm, depending on where along the circumference of the electrode 40 the measurement is taken. Such an adapted structure in the electrode 40 would be able to provide for limiting any side wall current leakage and to identify the potential of an increased exposed alloy layer 76 area projected on the discharge location thereby disproving the prevailing thought that such surface coatings are inherently ineffective. The following are examples detailing processes and constructions of tube electrodes in accordance with the present invention.

### EXAMPLE 1

A tube electrode construction identified as the GBT150 sample 140 was created using the process schedule itemized below:
1. Electroplate 6 μm of zinc on a 1.2 mm outer diameter/0.40 inner diameter, single channel tube preform of alloy 65Cu/35Zn.
2. Heat treat at 150° C. for 16 hours in air.
3. Draw in three passes (1.140-1.034-0.098 mm) to finish diameter.
4. Finish process (straighten, size, and cut to length).

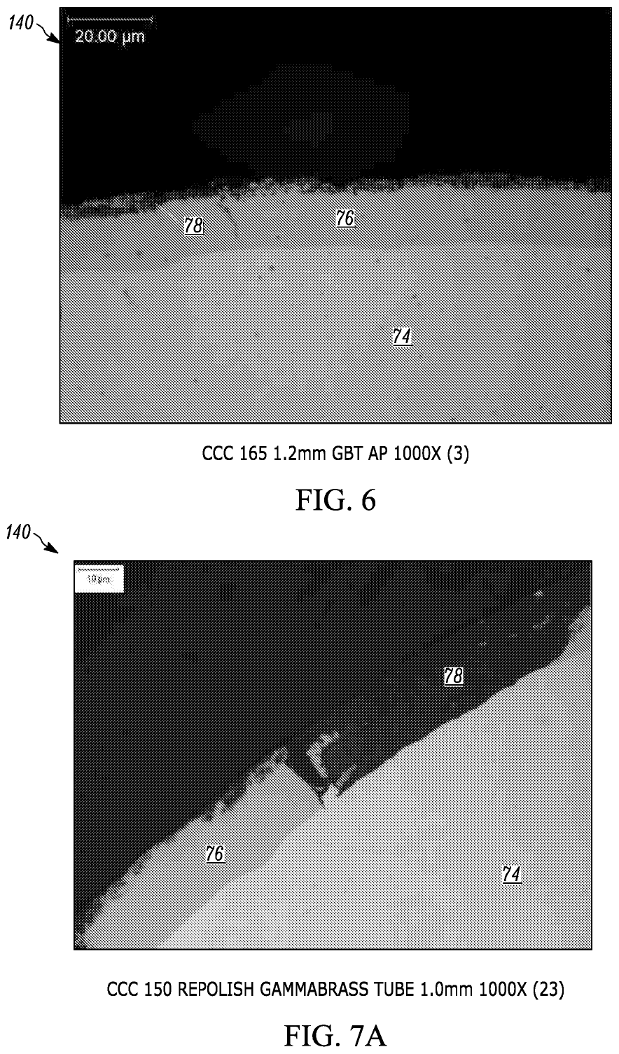

FIG. 6 is a metallographic image of the resultant tube electrode 140 cross-section taken at the conclusion of Step 2. Analysis of the microstructure in FIG. 6 and other random cross-sections of the tube electrode 140 indicates the GBT150 samples prior to drawing had a γ-phase brass alloy layer 76 approximately 18-20 μm thick and an oxide layer 78 which was at least 4+μm thick.

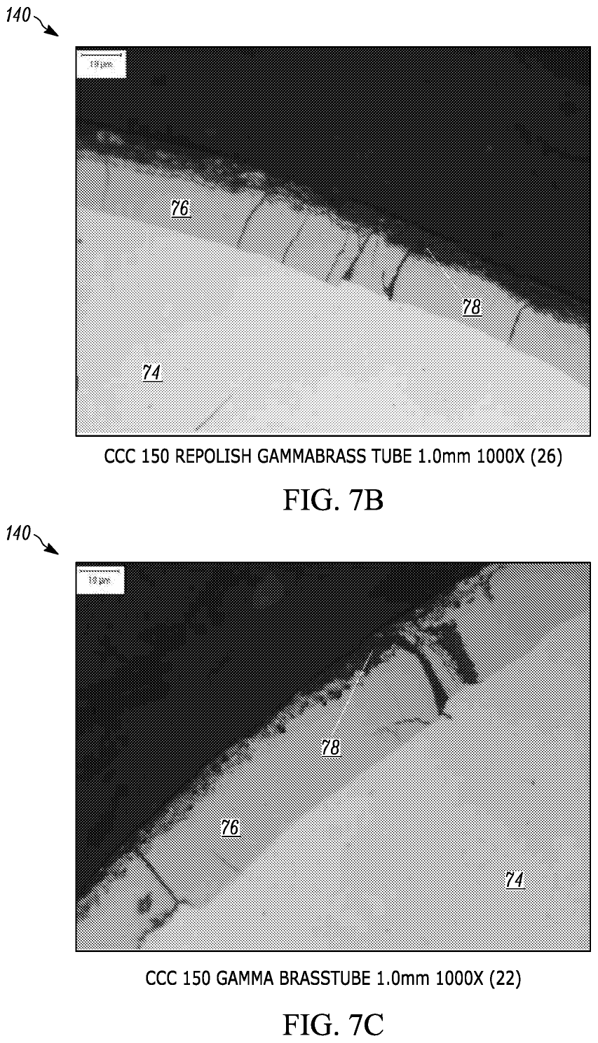

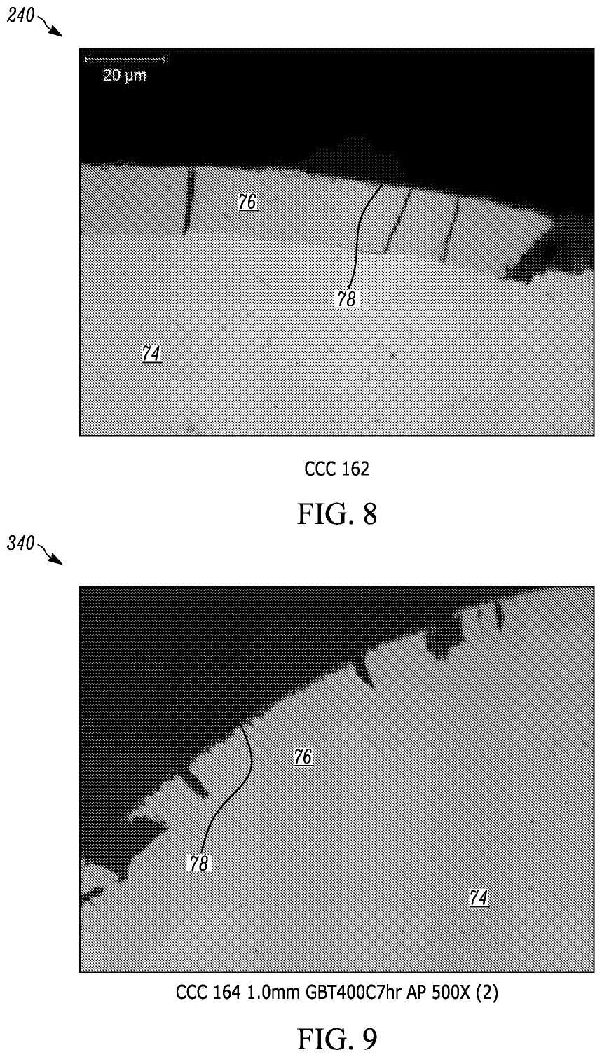

FIGS. 7A-7C illustrate different area about the circumference of a single cross-section of a finished tube electrode 140 of the GBT150 sample where the γ-phase brass layer 76 has radially fractured and the oxide layer 78 is not uniform around the tube circumference. In some areas, the oxide layer 78 is thicker where it has agglomerated (FIG. 7A). In other areas, the oxide layer 78 is reasonably unchanged where there was better bonding with the underlying brass layer 76 and, thus, the oxide layer was undisturbed by the drawing process. In still some other areas, the oxide layer 78 appears to have been stripped off the tube electrode 140 so as to be essentially removed (FIG. 7C).

The fracturing of the γ-phase brass alloy layer 76 was expected as it is well known in the prior art wire EDM technology that the extreme brittleness of the γ-phase brass alloy results in it not being able to tolerate deformation processing, such as wire or potentially tube drawing (see Tomalin (U.S. Pat. No. 5,945,010). As a result, the coating layer thicknesses of γ-phase brass alloy coated wire is typically limited to less than 6 μm since the wire application usually requires the wire electrodes to be hard drawn to tensile strengths of 750-900 N/mm² to facilitate auto-threading wire accessories. On the other hand, tube drawing is more of an elongation rather than a deformation process and, thus, thicker γ-phase brass coatings can be utilized on the milling tubes such as those in the present invention.

### EXAMPLE 2

To further illustrate the versatility available in diffusion anneal coated tube electrodes, some of the GBT150 samples 140 prepared in Example 1 were heat treated a second time to form GBT400 tube electrode samples 340 shown in FIG. 9. The second heat treatment was performed at 400° C. for 7 hours in a dynamic (flowing) air atmosphere. The higher temperature heat treatment converted the brass alloy layer 76 from γ-phase brass to β-phase brass, which has several significant consequences.

Although the zinc content of β-phase brass is lower than that of γ-phase brass (45% zinc versus 65% zinc), the diffusion anneal drives the zinc radially inward from the brass alloy layer 76—deeper into the core inner shell 74. This thickens the brass alloy layer 76, as illustrated in FIG. 9, from 18-20 μm to 26-28 μm. This thicker coating increases the coating area percentage of the exposed face on the end 44 of the tube electrode tube 340 of the GBT400 coating to 23.7%, compared to an 8.9% value for the GBT150 samples 140. Further, the β-phase brass coating 76 of the GBT400 sample 340 is considerably more ductile than that of the γ-phase brass coating of the GBT150 sample 140. This would provide significantly more latitude in processing the coated tubes to finish size without fracturing the coating were it to be drawn directly to finish size after heat treatment. For the purpose of illustration here, the conversion to a β-phase brass alloy layer 76 was performed at the finish size of the electrode 340 processing sequence but it also could be performed after the zinc deposition process (Step 1), and would be capable of being drawn to the same finish diameter because of its adequate ductility even though it is often reported to be a “brittle phase”.

### EXAMPLE 3

A large number of the applications for fast hole drilling EDM require a hole diameter ranging in size from 0.5 mm to 1.0 mm. Therefore, a tube electrode construction identified as the GBT150-0.5 sample 440 was created using the process schedule itemized below:
1. Electroplate 6 μm of zinc on a 1.2 mm outer diameter/0.92 inner diameter, single channel tube preform of alloy 65Cu/35Zn.
2. Heat treat at 150° C. for 16 hours in air.
3. Draw in six passes (1.083-0.99-0.892-0.75-0.593-0.493 mm) to finish diameter.
4. Finish process (straighten, size, and cut to length).

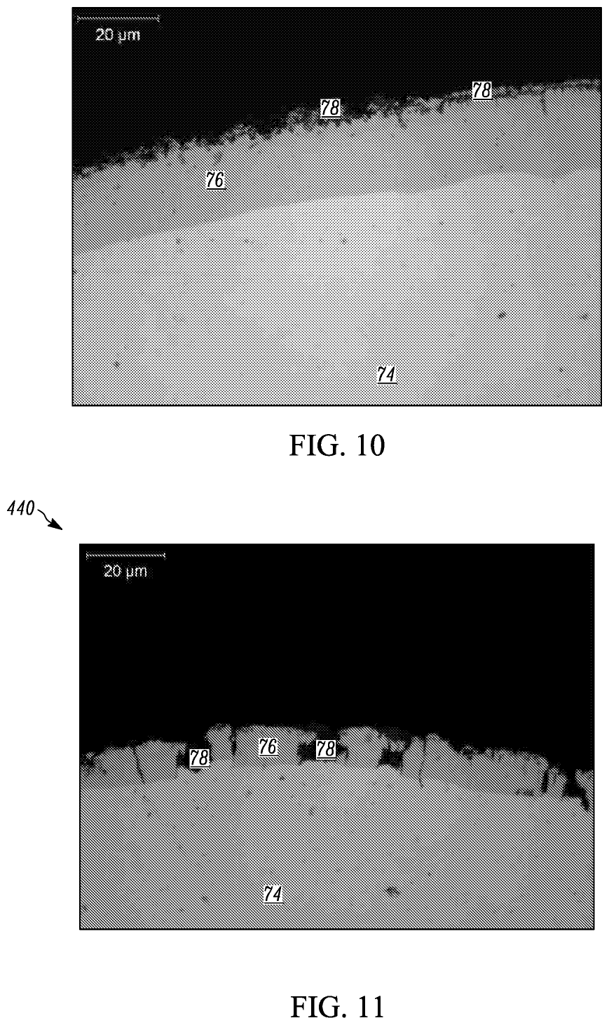

FIG. 10 is a metallographic image of the resultant tube electrode 440 cross-section taken at the conclusion of Step 2. Analysis of the microstructure in FIG. 10 and other random cross-sections of the tube electrode 440 indicates the GBT150-0.5 samples prior to drawing had a γ-phase brass alloy layer 76 approximately 12-18 μm thick and an oxide layer 78 which is 2-4 μm thick. FIG. 11 illustrates the cross-section of a finished tube electrode 440 of the GBT150-0.5 sample where the γ-phase brass layer 76 has been fractured during drawing. The oxide layer 78 has been agglomerated and is uniformly, but discontinuously, distributed around the circumference of the tube electrode 440.

### Results

### Comparison to State of the Art Tube Electrode Performance

The two applications of the fast hole drilling technology that are important to high temperature turbine design are through hole drilling of cooling passages and shaped hole drilling of diffuser pockets (see Forrester—U.S. Pat. No. 7,041,933). Performance test comparisons were made between tube electrodes of the current invention and state of the art tube electrodes on state of the art equipment in use for both applications. The state of the art electrodes used for comparison were single channel, uncoated brass (65Cu/35Zn) tubes 300 mm in length which were sourced from Global EDM Supplies, Part No. BR-1x300T for 1.0 mm diameter and BR-0.5x300T for 0.5 mm diameter.

To evaluate the GBT150 sample 140 of the current invention, through hole performance tests were performed on an Ocean FH350 CNC 32 amp model machine tool. Three holes were machined in a 1.0 inch thick block of D-2 tool steel hardened to R_{c} 52-54. Both electrode types were operated on the manufacturer's recommended technology for the test conditions which is designated “SKD 1.0 mm tech” and both electrode types were operated under that standard technology to a full depth of 1.0 inch with a flushing pressure of 800 PSI. The parameters for the “SKD 1.0 mm tech” were:

| On time | Off time | IP | VS | C Box | Gap | Rot-S | Feed | Pulse |
|---|---|---|---|---|---|---|---|---|
| 30 | 20 | 15 | 3 | 0 | 24 | 15 | 30 | 0 |

The results of this series of test are summarized below:

### Brass Electrode:

| | | | Time | Total time | |
|---|---|---|---|---|---|
| Hole | Amps | Break thru | to break thru | (break thru-finish) | Hole Ø |
| 1 | 9-10 | 1.70″ | 00:01:03 | 00:02:49 | 0.040″ |
| 2 | 9-10 | 1.82″ | 00:01:04 | 00:02:03 | 0.042″ |
| 3 | 9-10 | 1.87″ | 00:01:06 | 00:01:43 | 0.041″ |

### GBT150 (Gamma Phase Brass Coated) Electrode:

| | | | Time | Total time | |
|---|---|---|---|---|---|
| Hole | Amps | Break thru | to break thru | (break thru-finish) | Hole Ø |
| 1 | 11-12 | 1.70″ | 00:00:54 | 00:01:40 | 0.042″ |
| 2 | 11-12 | 1.72″ | 00:00:58 | 00:01:40 | 0.042″ |
| 3 | 11-12 | 1.87″ | 00:01:00 | 00:01:40 | 0.042″ |

### GBT400 (Beta Phase Brass Coated) Electrode:

| | | | Time | Total time | |
|---|---|---|---|---|---|
| Hole | Amps | Break thru | to break thru | (break thru-finish) | Hole Ø |
| 1 | 11-12 | 1.78″ | 00:00:58 | 00:01:31 | 0.043″ |
| 2 | 11-12 | 1.80″ | 00:00:56 | 00:01:28 | 0.043″ |
| 3 | 11-12 | 1.87″ | 00:00:57 | 00:01:29 | 0.043″ |

To evaluate the GBT150-0.5 sample of the current invention, through hole performance tests were also performed on an Ocean FH350 CNC 32 amp model machine tool. Three consecutive holes were machined in a 0.285 inch thick block of D-2 tool steel hardened to R_{c} 52-54. Both electrode types were operated on the manufacturer's recommended technology for the test conditions which is designated “SKD 0.5 mm tech” and both electrode types were operated under that standard technology to a full depth of 1.0 inch with a flushing pressure of 1000 PSI. The parameters for the “SKD 0.5 mm tech” were:

| On time | Off time | IP | VS | CBox | Gap | Rot-S | Feed | Pulse |
|---|---|---|---|---|---|---|---|---|
| 25 | 20 | 10 | 2 | 0 | 22 | 15 | 30 | 0 |

The results of these tests were:

### Brass Electrode:

| | | | Time | Total time | |
|---|---|---|---|---|---|
| Hole | Amps | Break thru | to break thru | (break thru-finish) | Hole Ø |
| 1 | 7-8 | 0.46″ | 00:00:18 | 00:00:38 | 0.022″ |
| 2 | 7-8 | 0.52″ | 00:00:28 | 00:00:49 | 0.022″ |
| 3 | 7-8 | 0.59″ | 00:01:06 | 00:02:15 | 0.022″ |

### GBT150-0.5 Electrode:

| | | | Time | Total time | |
|---|---|---|---|---|---|
| Hole | Amps | Break thru | to break thru | (break thru-finish) | Hole Ø |
| 1 | 8-9 | 0.45″ | 00:00:14 | 00:00:32 | 0.022″ |
| 2 | 8-9 | 0.46″ | 00:00:16 | 00:00:34 | 0.022″ |
| 3 | 8-9 | 0.47″ | 00:00:18 | 00:00:36 | 0.022″ |

The EDM machine tool used to evaluate the performance observed in shaping a simulated diffuser pocket profile with each electrode type was a Beaumont Model BM 8060-63A. The workpiece was a sheet of Inconel 0.125 inch thick positioned at angle of 60° to simulate a blade component for a turbine. The results of this series of tests together with the adjustments made to the machine technology for both electrode types which minimized short circuit interruptions are summarized below:

| On time | Off time | IP | C Box | Feed |
|---|---|---|---|---|
| 30 | 20 | 18 | 0 | 3.0 |

Three shaped pockets were formed in each workpiece from each electrode. The same settings and conditions were used for each cut, to a full depth of 1.0 inch with a flushing pressure of 800 PSI.

### Brass Electrode:

| Shape | Total time |
|---|---|
| 1 | 00:02:30 |
| 2 | 00:02:37 |
| 3 | 00:02:41 |

### GBT150 (Gamma Phase Brass Coated) Electrode:

| Shape | Total time |
|---|---|
| 1 | 00:01:41 |
| 2 | 00:01:36 |
| 3 | 00:01:38 |

### GBT400 (Beta Phase Brass Coated) Electrode:

| Shape | Total time |
|---|---|
| 1 | 00:02:27 |
| 2 | 00:01:48 |
| 3 | 00:01:52 |

### Through-Hole Performance Analysis

Using Ocean's suggested machine technology for 1.0 mm diameter tube electrodes, all of the coated tube electrodes of the present invention equaled or outperformed the state of the art brass tube electrodes. The coated electrodes of the present invention marginally reduced the cycle time to break-through by an approximate 2-5% compared to the brass electrode. However, total cycle time per hole with the coated electrodes of the present invention was reduced by about 25-30% compared to the state of the art brass electrodes.

Some of the advantage of the coated tube types was probably due to the marginally higher current the coated types drew, but the largest contribution to the reduction in total cycle time was due to the coatings' ability to dress the burr on the exit edge after the internal flush was lost at break-through. The coated electrodes exhibited noticeably less shorting which required the electrode to be temporarily withdrawn to clear the short circuit throughout the cycle, but after break-through the reduction in shorting was dramatic. In the case of the prior art 0.5 mm brass electrodes, it is clear from the test results that the electrode end deteriorated with each pass, causing the time for break-through and the total time for each pass to consecutively increase with increasing increments. By way of contrast the coating on the GBT500-0.5 sample of the present invention maintained the end integrity of the electrode, thereby providing consistent performance with each pass. Although the initial cutting speeds of the brass and coated electrodes were approximately equal at the smaller 0.5 mm diameter, the coated electrode could maintain that performance with consecutive operations whereas the bare brass electrode could not. This is desirable in industrial applications where multiple hole drilling operations are very common.

### Diffuser Pocket Performance Analysis

The cycle time for milling the simulated pocket cavity was decreased by more than 50% for both coated electrode types compared to the state of the art brass tube electrode, which clearly establishes the advancement of the present invention over the prior art for fast hole drilling EDM applications. The most surprising result of the analysis is the performance of the β-phase brass coated electrode GBT400 sample 340. More specifically, the GBT400 sample 340 that had received a second heat treatment at finish size resulted in a fully recrystallized microstructure. It has been suggested that annealed microstructures in the wire EDM application posses the fastest cutting speeds (see EDM Today Magazine, Volume 24, Issue 3, pg 34) but the common practice in the wire EDM application is to use fully hardened wires primarily because of their mechanical stability in automatic wire threading operations.

The rotating aspect of the tube electrode in fast hole drilling also benefits from a similarly hard, as-drawn microstructure as in the wire application. The annealed microstructure of GBT400 was considered an acceptable risk to take in order to conveniently demonstrate the versatility the diffusion anneal process as applied to fast hole drilling electrode construction. Using a heat treatment to form a β-phase layer or a duplex γ/β phase layer prior to tube reduction in Step 3 would be a desirable process sequence.

The diffusion anneal process for constructing brass tube electrodes provides a myriad of potential metallurgical combinations for improved EDM milling tube electrodes to take advantage of the inherent physical and chemical properties of the coat specie in addition to the physical state resulting from the processing of the coating during tube fabrication.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An apparatus for an electrical discharge machine for milling a shaped cavity in a workpiece comprising:
a hollow electrode having a metallic inner shell including at least one passage for receiving dielectric fluid; and
a layer having at least one brass alloy provided over the inner shell and exhibiting a zinc content greater than a zinc content of the inner shell.

2. The apparatus of claim 1, wherein the inner shell comprises one of copper and a copper alloy.

3. The apparatus of claim 1, wherein the brass alloy layer comprises γ-phase brass.

4. The apparatus of claim 1, wherein the brass alloy layer comprises β-phase brass.

5. The apparatus of claim 1, wherein the brass alloy layer comprises a duplex γ/β-phase brass alloy.

6. The apparatus of claim 1, wherein the brass alloy layer has a thickness of about 10-40 μm.

7. The apparatus of claim 1 further comprising a nonmetallic layer including zinc oxide extending over the brass alloy layer and defining the outer surface of the electrode.

8. A method of forming an electrode for an electrical discharge machine for drilling a hole in a workpiece comprising:
providing a metallic inner shell having at least one passage for receiving dielectric fluid;
depositing a layer of zinc over the inner shell to form a composite electrode;
heat treating the composite electrode in an oxygen environment to form a layer having at least one brass alloy over the inner shell; and
drawing the composite electrode down to a finish diameter.

9. The method of claim 8, wherein the metallic inner shell comprises one of copper and a copper alloy.

10. The method of claim 8, wherein the brass alloy layer comprises β-phase brass alloy.

11. The method of claim 8, wherein the brass alloy layer comprises γ-phase brass alloy.

12. The method of claim 8, wherein the brass alloy layer comprises a duplex γ/β-phase brass alloy.

13. The method of claim 8, wherein the brass alloy layer has a thickness of about 10-40 μm.

14. The method of claim 8, wherein the step of heat treating comprises:
heating the composite electrode a first time in an oxygen atmosphere at a first temperature; and
heating the composite electrode a second time in an oxygen atmosphere at a second temperature greater than the first temperature.

15. The method of claim 8, wherein heat treating the composite electrode forms an intermediate layer of β-phase brass between the core and a γ-phase brass layer.

16. The method of claim 15, wherein drawing the composite fire forms discontinuities in the γ-phase brass layer and extrudes the β-phase brass wire into the discontinuities.

17. The method of claim 8, wherein the γ-phase brass layer is continuous.

18. The method of claim 8, wherein drawing the composite wire forms discontinuities in the γ-phase brass layer.
